(19) United States
(12) Patent Application Publication
(10) Pub. No.: US 2026/0328894 A1
(43) Pub. Date: Oct. 22, 2026

(54) ELECTRONIC DEVICE AND METHOD OF DETERMINING SOUND SOURCE

(71) Applicants: Hyundai Motor Company, Seoul (KR); Kia Corporation, Seoul (KR)

(72) Inventors: Ho Geon Yu, Hwaseong-si (KR); Eui Hyeok Lee, Hwaseong-si (KR); Hyun Sik Choi, Hwaseong-si (KR)

(21) Appl. No.: 19/308,927

(22) Filed: Aug. 25, 2025

(30) Foreign Application Priority Data
Apr. 22, 2025 (KR) 10-2025-0052564

(51) Int. Cl. G01S 5/26; H04R 1/08

(52) U.S. Cl. CPC G01S 5/26; H04R 1/08

(57) ABSTRACT

Disclosed are embodiments of an electronic device and a method of determining a sound source. The electronic device includes a memory that stores a computer-executable instruction, and a processor that accesses the memory and executes the instruction, wherein the processor may determine sound source data including omnidirectional information of a sound source and directional information of the sound source, obtain input data by preprocessing the sound source data, and obtain a location of the sound source and whether an event of the sound source occurs by applying the input data to a sound source detection model, wherein the sound source detection model may include a first block and a second block associated with an attention mechanism.

### CROSS-REFERENCE TO RELATED APPLICATIONS

This application claims the benefit of and priority to Korean Patent Application No. 10-2025-0052564, filed in the Korean Intellectual Property Office on Apr. 22, 2025, the entire contents of which are incorporated herein by reference.

### TECHNICAL FIELD

The present disclosure relates to an electronic device and a method of determining a sound source, and more particularly, to a technique for determining the direction of sound and the type of sound.

### BACKGROUND

Recently, sound event localization and detection (SELD) technology using deep learning has been actively studied and used to recognize sound events and predict spatial locations in various real environments. Generally, an SELD system includes a complex task of simultaneously predicting the presence or absence of a sound event (sound event detection (SED)) and the direction of arrival (DOA), and its structure has become more complex recently with the inclusion of an additional subtask such as sound distance estimation (SDE).

However, the increase of subtasks is the main cause of lowering the prediction performance of deep learning models based on existing single-task systems. That is, when a single integrated model is requested to handle multiple inference objectives simultaneously, the learning interference between different prediction objectives may occur, which ultimately leads to a decrease in overall performance.

Existing SELD models are generally configured to extract temporal and spatial information from input sound features (such as log-mel spectrogram) based on convolutional neural network (CNN) and recurrent neural network (RNN) structures and predict SED and DOA. However, such structures lack the ability to focus on a specific direction like humans or to separate and recognize sound events based on directional information.

A human auditory cognitive system has the ability to selectively focus on a sound source originating in a specific direction and analyze the pattern of a sound signal received temporally in that direction to infer what kind of event the sound is. Approaches that mimic these cognitive processes are useful for enabling deep learning models to make more accurate predictions even in complex environments.

Therefore, a new deep learning-based network structure may be developed that may improve the degradation of prediction performance due to the increase in subtasks and more effectively integrate and process directionality and event information by mimicking human auditory cognitive ability.

### SUMMARY

The present disclosure has been made to solve the above-mentioned problems occurring in the prior art while advantages achieved by the prior art are maintained intact.

An embodiment of the present disclosure provides an electronic device and a method of determining a sound source capable of improving the performance degradation of a conventional single-task system in a composite sound event localization and detection (SELD) system that estimates not only the direction of arrival (DOA) of a sound event but also the distance (sound distance estimation (SDE)).

Another embodiment of the present disclosure provides an electronic device and a method of determining a sound source capable of maintaining stable and consistent performance even in a new acoustic scene or unknown environment through a network structure configured so that information on the direction and distance of an event are clearly separated and learned.

Still another embodiment of the present disclosure provides an electronic device and a method of determining a sound source capable of supporting the performance of rescue and response missions by accurately determining the location of occurrence of incident-related sounds such as gunshots, glass breaking sounds, and screams in a CCTV surveillance system, safely performing monitoring by determining the location and type of an event such as a baby crying, a doorbell, and an elderly person falling in a smart home environment, and implementing natural interaction with a user based on spatial understanding of the surrounding acoustic environment when applied to a service robot. Note the term “surrounding” is intended to generally include acoustics determinable in the vicinity of the service robot.

The technical problems to be solved by the present disclosure are not limited to the aforementioned problems, and any other technical problems not mentioned herein will be clearly understood from the following description by those skilled in the art to which the present disclosure pertains.

According to an embodiment of the present disclosure, an electronic device includes a memory that stores a computer-executable instruction, and a processor that accesses the memory and executes the instruction, wherein the processor identifies sound source data including omnidirectional information of a sound source and directional information of the sound source, obtains input data by preprocessing the sound source data, and obtains a location of the sound source and whether an event of the sound source occurs by applying the input data to a sound source detection model, and wherein the sound source detection model includes a first block and a second block regarding, e.g., associated with, an attention mechanism.

According to an embodiment, the processor may obtain the sound source from an external device that obtains a signal associated with a first channel, obtain the sound source data associated with a second channel by applying the sound source to a specified filter, obtain a first spectrum associated with a time at which the sound source is obtained and a frequency of the sound source by performing a Fast Fourier transform on the sound source data, and obtain a second spectrum having a specified number of dimensions by applying a filter associated with a mel-scale to the first spectrum.

According to an embodiment, the processor may obtain an intensity vector of the second spectrum to reflect a spatial feature of the sound source, and obtain the input data by concatenating the second spectrum and the intensity vector.

According to an embodiment, the processor may obtain a feature map including a feature associated with convolution of the input data by applying the input data to a plurality of convolutional layers associated with a convolutional neural network included in the sound source detection model, and apply the feature map to the first block.

According to an embodiment, the processor may obtain a first embedding including information about the location of the sound source by applying the feature map to a first channel-spectro-temporal (CST) block included in the first block, and obtain a direction-of-arrival (DOA) guidance feature by applying the feature map and the first embedding to a DOA guidance attention block included in the first block.

According to an embodiment, the processor may apply the feature map as a key and a value of the DOA guidance attention block, and apply the first embedding as a query of the DOA guidance attention block.

According to an embodiment, the processor may obtain a second embedding including information about the event of the sound source by applying the DOA guidance feature to a second CST block included in the second block, and obtain an event guidance feature by applying the feature map and the second embedding to an event guidance attention block included in the second block.

According to an embodiment, the processor may apply the DOA guidance feature as a key and a value of the event guidance attention block, and apply the second embedding as a query of the event guidance attention block.

According to an embodiment, the processor may obtain the location of the sound source and whether the event of the sound source occurs by applying the event guidance feature to a third CST block connected to the event guidance attention block.

According to another embodiment of the present disclosure, a method of determining a sound source includes determining sound source data including omnidirectional information of the sound source and directional information of the sound source, obtaining input data by preprocessing the sound source data, and obtaining a location of the sound source and whether an event of the sound source occurs by applying the input data to a sound source detection model, wherein the sound source detection model includes a first block and a second block associated with an attention mechanism.

According to an embodiment, the obtaining of the location of the sound source and whether the event of the sound source occurs may include obtaining the sound source from an external device that obtains a signal associated with a first channel, obtaining the sound source data associated with a second channel by applying the sound source to a specified filter, obtaining a first spectrum associated with a time at which the sound source is obtained and a frequency of the sound source by performing a Fast Fourier transform on the sound source data, and obtaining a second spectrum having a specified number of dimensions by applying a filter associated with a mel-scale to the first spectrum.

According to an embodiment, the obtaining of the location of the sound source and whether the event of the sound source occurs may include obtaining an intensity vector of the second spectrum to reflect a spatial feature of the sound source, and obtaining the input data by concatenating the second spectrum and the intensity vector.

According to an embodiment, the obtaining of the location of the sound source and whether the event of the sound source occurs may include obtaining a feature map including a feature associated with convolution of the input data by applying the input data to a plurality of convolutional layers associated with a convolutional neural network included in the sound source detection model, and applying the feature map to the first block.

According to an embodiment, the obtaining of the location of the sound source and whether the event of the sound source occurs may include obtaining a first embedding including information about the location of the sound source by applying the feature map to a first channel-spectro-temporal (CST) block included in the first block, and obtaining a direction-of-arrival (DOA) guidance feature by applying the feature map and the first embedding to a DOA guidance attention block included in the first block.

According to an embodiment, the obtaining of the location of the sound source and whether the event of the sound source occurs may include applying the feature map as a key and a value of the DOA guidance attention block, and applying the first embedding as a query of the DOA guidance attention block.

According to an embodiment, the obtaining of the location of the sound source and whether the event of the sound source occurs may include obtaining a second embedding including information about the event of the sound source by applying the DOA guidance feature to a second CST block included in the second block, and obtaining an event guidance feature by applying the feature map and the second embedding to an event guidance attention block included in the second block.

According to an embodiment, the obtaining of the location of the sound source and whether the event of the sound source occurs may include applying the DOA guidance feature as a key and a value of the event guidance attention block, and applying the second embedding as a query of the event guidance attention block.

According to an embodiment, the obtaining of the location of the sound source and whether the event of the sound source occurs may include obtaining the location of the sound source and whether the event of the sound source occurs by applying the event guidance feature to a third CST block connected to the event guidance attention block.

### BRIEF DESCRIPTION OF THE DRAWINGS

The above and other embodiments, features and advantages of the present disclosure will be more apparent from the following detailed description taken in conjunction with the accompanying drawings:

FIG. 1 is a block diagram illustrating an electronic device according to an embodiment of the present disclosure;

FIG. 2 is a flowchart illustrating a method of determining a sound source according to an embodiment of the present disclosure;

FIG. 3 is a block diagram illustrating a sound source detection model in an electronic device according to an embodiment of the present disclosure;

FIG. 4 is a diagram illustrating a convolutional neural network included in a sound source detection model in an electronic device according to an embodiment of the present disclosure;

FIG. 5 is a diagram illustrating a first block included in a sound source detection model in an electronic device according to an embodiment of the present disclosure;

FIG. 6 is a diagram illustrating a second block included in a sound source detection model in an electronic device according to an embodiment of the present disclosure;

FIG. 7 is a diagram illustrating an output layer included in a sound source detection model in an electronic device according to an embodiment of the present disclosure; and

FIG. 8 is a block diagram illustrating a computing system related to an electronic device or a method of determining a sound source according to an embodiment of the present disclosure.

With regard to description of drawings, the same or similar elements may be marked by the same or similar reference numerals.

### DETAILED DESCRIPTION OF ILLUSTRATIVE EMBODIMENTS

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of the related known configuration or function will be omitted when it is determined that it interferes with the understanding of the embodiment of the present disclosure. Various embodiments of the present disclosure may be described with reference to accompanying drawings. Accordingly, those of ordinary skill in the art will recognize that modification, equivalent, and/or alternative on the various embodiments described herein can be variously made without departing from the scope and spirit of the present disclosure. With regard to description of drawings, similar elements may be marked by similar reference numerals.

Terms, such as first, second, A, B, (a), (b) or the like may be used herein when describing components of the present disclosure. The terms are provided only to distinguish the elements from other elements, and the essences, sequences, orders, and numbers of the elements are not limited by the terms. In addition, unless defined otherwise, all terms used herein, including technical or scientific terms, have the same meanings as those generally understood by those skilled in the art to which the present disclosure pertains. The terms defined in the generally used dictionaries should be construed as having the meanings that coincide with the meanings of the contexts of the related technologies, and should not be construed as ideal or excessively formal meanings unless clearly defined in the specification of the present disclosure. The terms, such as “first”, “second”, and the like used herein may refer to various elements of various embodiments of the present disclosure, but do not limit the elements. For example, “a first user device” and “a second user device” indicate different user devices regardless of the order or priority. For example, without departing the scope of the present disclosure, a first element may be referred to as a second element, and similarly, a second element may be referred to as a first element.

In the present disclosure disclosed herein, the expressions “have”, “may have”, “include” and “comprise”, or “may include” and “may comprise” used herein indicate existence of corresponding features (e.g., elements such as numeric values, functions, operations, or components) but do not exclude presence of additional features.

It will be understood that when an element (e.g., a first element) is referred to as being “(operatively or communicatively) coupled with/to” or “connected to” another element (e.g., a second element), it may be directly coupled with/to or connected to the other element or an intervening element (e.g., a third element) may be present. In contrast, when an element (e.g., a first element) is referred to as being “directly coupled with/to” or “directly connected to” another element (e.g., a second element), it should be understood that there is no intervening element (e.g., a third element).

According to the situation, the expression “configured to” used herein may be used as, for example, the expression “suitable for”, “having the capacity to”, “designed to”, “adapted to”, “made to”, or “capable of”.

The term “configured to” must not mean only “specifically designed to” in hardware. Instead, the expression “a device configured to” may mean that the device is “capable of” operating together with another device or other components. CPU, for example, a “processor configured to perform A, B, and C” may mean a dedicated processor (e.g., an embedded processor) for performing a corresponding operation or a generic-purpose processor (e.g., a central processing unit (CPU) or an application processor) which may perform corresponding operations by executing one or more software programs which are stored in a memory device. Terms used in this disclosure are used to describe specified embodiments of the present disclosure and are not intended to limit the scope of the present disclosure. The terms of a singular form may include plural forms unless otherwise specified. All the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal detect unless expressly so defined herein in various embodiments of the present disclosure. In some cases, even if terms are terms which are defined in the present disclosure, they may not be interpreted to exclude embodiments of the present disclosure.

In the present disclosure disclosed herein, the expressions “A or B”, “at least one of A or/and B”, or “one or more of A or/and B”, and the like used herein may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included. In addition, as used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. In particular, a phrase such as “at least one of A, B, C, or any combination thereof” may include A or B or C or a combination thereof such as AB or ABC.

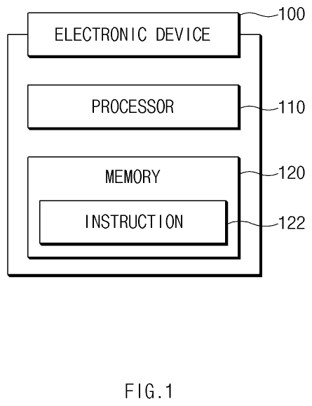

Hereinafter, embodiments of the present disclosure will be described in detail with reference to FIGS. 1 to 8.

FIG. 1 is a block diagram illustrating an electronic device according to an embodiment of the present disclosure.

An electronic device 100 according to an embodiment may include a processor 110 and a memory 120 including instructions 122. The electronic device 100 may represent a device that preprocesses input sound source data including omnidirectional information and directional information of a sound source, and estimates the location (DOA) of the sound source and whether an event occurs (SED) through a deep learning-based sound source detection model including a convolutional neural network and an attention-based block. For example, the electronic device 100 may perform separate learning and integrated inference of location information and event information at each stage through direction guidance attention (DOA) using DOA embedding and event guidance attention using event embedding.

The processor 110 may execute software and control at least one other component (e.g., a hardware or software component) connected to the processor 110. The processor 110 may also perform various data processing or operations. For example, the processor 110 may store a sound source, sound source data, input data, a sound source detection model, a location of the sound source, or whether an event of the sound source occurs in the memory 120.

For reference, the processor 110 may perform all operations performed by the electronic device 100. Therefore, for convenience of explanation, in this specification, the operation performed by the electronic device 100 is mainly described as an operation performed by the processor 110.

In addition, for convenience of explanation in this specification, the processor 110 is mainly described as one processor, but is not limited thereto. For example, the electronic device 100 may include processors. Each of the processors may perform all operations related to a sound source detection operation.

The memory 120 may temporarily and/or permanently store various data and/or information required to perform sound source detection. For example, the memory 120 may store the sound source, the sound source data, the input data, the sound source detection model, the location of the sound source, or whether an event of the sound source occurs.

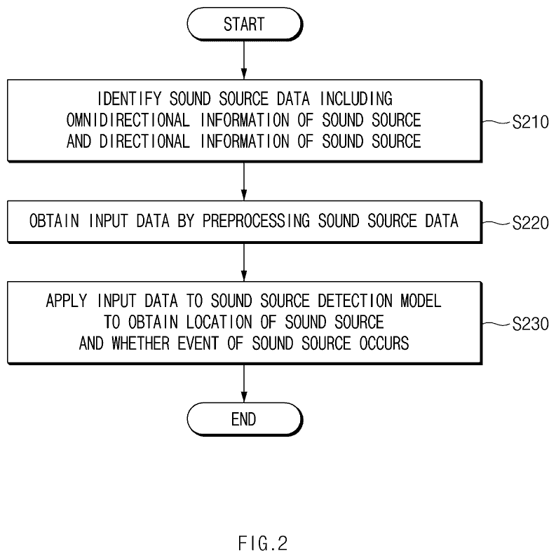

FIG. 2 is a flowchart illustrating a method of determining a sound source according to an embodiment of the present disclosure.

A processor (e.g., the processor 110 of FIG. 1) according to an embodiment of the present disclosure may determine sound source data including omnidirectional information of a sound source and directional information of the sound source in operation S210.

For example, a sound source, which refers to a real or virtual object that generates a sound signal in the air, may include the origin of various types of sound signals generated in the form of human voice, machine sound, music, or warning sounds.

For example, omnidirectional information of a sound source may mean information that includes sound energy received from all directions on average regardless of the directionality of the sound, and may be obtained from an audio signal received through an omnidirectional microphone.

For example, the directional information of the sound source may refer to information about the direction in space (e.g., azimuth, altitude angle, and the like) in which the sound source originates, and may be extracted from a sound signal received through an 8-shaped directional microphone for each spatial axis (x-axis, y-axis, and z-axis).

For example, sound source data, which are composed by converting a sound signal received for one or more sound sources into a digital signal, may mean a data set that includes at least one piece of omnidirectional information of the sound source and directional information of the sound source.

In operation S220, the processor may obtain input data by preprocessing sound source data.

For example, the input data, which are generated by performing preprocessing including time-frequency analysis and spatial feature extraction processes on sound source data, may mean a data set that includes a log-mel spectrogram of multiple channels and an intensity vector.

The processor may obtain a sound source from an external device that obtains a signal for a first channel (e.g., 32-th channel). The processor may obtain sound source data for a second channel (e.g., 4-th channel) by applying the sound source to a specified filter (e.g., an anechoic measurement-based filter).

The processor may obtain a first spectrum associated with the time at which the sound source is obtained and the frequency of the sound source by performing a fast Fourier transform on the sound source data. The processor may apply a filter on a mel-scale to the first spectrum to obtain a second spectrum (e.g., a log-mel spectrum) having a specified number of dimensions.

The processor may obtain input data by obtaining an intensity vector of the second spectrum to reflect a spatial feature of the sound source and performing concatenation of the second spectrum and the intensity vector.

In operation S230, the processor may apply the input data to the sound source detection model to obtain the location of the sound source and whether an event of the sound source occurs.

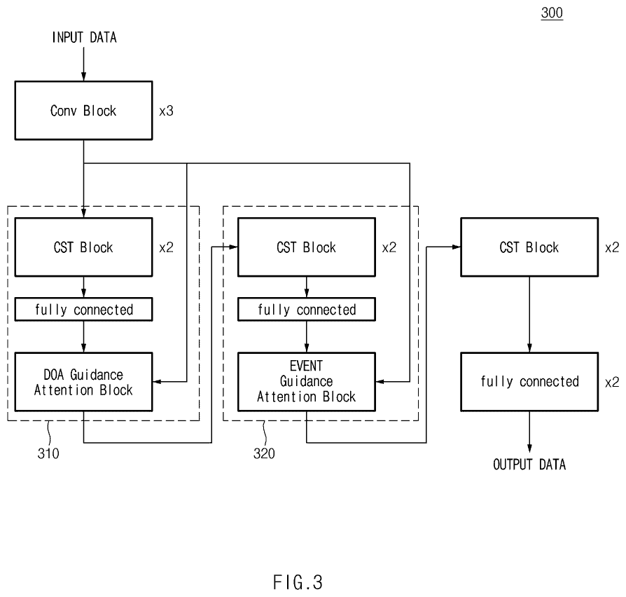

For example, the sound source detection model may mean a deep learning-based network that takes preprocessed input data (e.g., log-mel spectrum and intensity vector) as input and estimates the locations of one or more sound sources present in the input and whether an event occurs. The sound source detection model may include multiple convolution blocks (Conv Blocks), channel-spectro-temporal blocks (CST Blocks), DOA guidance attention blocks, event guidance attention blocks, and fully connected layers, and may generate an output in the Multi-ACCDOA format. The details of the sound source detection model will be described below with reference to FIGS. 3 to 7.

For example, the location of a sound source may refer to information indicating a direction in which the sound source originates in three-dimensional space, and may be expressed in the form of a unit vector based on an orthogonal coordinate system, typically based on the x-axis, y-axis, and z-axis. For convenience of explanation in the present specification, the location information of the sound source is described as being included as an (x, y, z) direction vector for each class of the Multi-ACCDOA output.

For example, whether an event of a sound source occurs may mean a signal or determination reference indicating whether an event corresponding to a sound source class has actually occurred in a specific time frame. In the present specification, for convenience of explanation, whether an event occurs is expressed based on the vector magnitude (e.g., norm) of the corresponding direction vector within the Multi-ACCDOA output, and is determined as an inactive state when the vector magnitude is close to ‘0 (zero)’, and as an active state when it is large.

FIG. 3 is a block diagram illustrating a sound source detection model in an electronic device according to an embodiment of the present disclosure.

FIG. 3 is a block diagram illustrating the configuration of a sound source detection model 300 according to an embodiment of the present disclosure. The sound source detection model 300 has a deep learning-based network structure for estimating the location or direction of a sound source (direction of arrival: DOA) and whether a sound event occurs (sound event detection (SED)) from input data.

The sound source detection model 300 may include a plurality of convolution blocks (Conv Blocks) for extracting input features, a first block 310 for extracting directional information based on an attention mechanism, a second block 320 for extracting event information, and a subsequent processing block for the final output.

The sound source detection model 300, which is a model that combines direction recognition and event recognition with sequential attention within a single lightweight structure, may overcome the generalization limitations of the existing single-task based SELD model and maintain high accuracy in various environments through the first block 310 associated with the DOA recognition function and the second block 320 associated with the SED recognition function.

The processor may train a sound source detection model. For example, the sound source detection model may include a neural network. The neural network may include a plurality of layers, and each layer may include a plurality of nodes. A node may have a node value determined based on an activation function. A node in an arbitrary layer may be connected to a node (e.g., another node) in another layer through a link (e.g., a connection edge) with a connection weight. The node value of a node may be propagated to other nodes through links. In the inference operation of a neural network, node values may be forward propagated from the previous layer to the next layer.

For example, in the sound source detection model, a forward propagation operation may represent an operation of propagating a node value based on input data in a direction from an input layer of the sound source detection model to an output layer. That is, a node value of a corresponding node may be propagated (e.g., forward propagation) to a node (e.g., a next node) of a next layer connected to a node through a connection edge. For example, a node may receive a value weighted by a connection weight from a previous node (e.g., a plurality of nodes) connected through a connection edge.

A node value of a node may be determined based on applying an activation function to a sum (e.g., a weighted sum) of weighted values received from previous nodes. Parameters of the neural network may include the connection weight described above as an example. The parameters of the neural network may be updated such that the value of an objective function changes in a targeted direction (e.g., a direction in which loss is minimized).

For example, the trained sound source detection model may represent a model trained through machine learning, and may be a trained machine learning model that outputs a training output (e.g., the location of the sound source and whether an event of the sound source occurs) from a training input (e.g., input data).

A machine learning model (e.g., a trained sound source detection model) may be generated through machine learning. For example, a learning algorithm may include supervised learning, unsupervised learning, semi-supervised learning, or reinforcement learning, but is not limited to the above examples.

The machine learning model may include a plurality of artificial neural network layers. The artificial neural network may include at least one of a deep neural networks (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination thereof, but embodiments are not limited to the above examples.

In supervised learning, the machine learning model described above may be trained based on training data including pairs of training inputs and training outputs mapped to the corresponding training inputs. For example, the machine learning model may be trained to output training outputs from training inputs. During training, the machine learning model may generate interim outputs based at least in part on training inputs, and may be trained to minimize the loss between the interim outputs and the training outputs (e.g., the target of the training). During the learning process, parameters of a machine learning model (e.g., connection weights between nodes/layers in a neural network) may be updated based on the loss. Such learning may be performed, for example, in an electronic device itself (e.g., the electronic device 100 of FIG. 1) on which the machine learning model is executed, or may be performed through a separate server. A machine learning model (e.g., a learned sound source detection model) that completes learning may be stored in a memory (e.g., the memory 120 of FIG. 1).

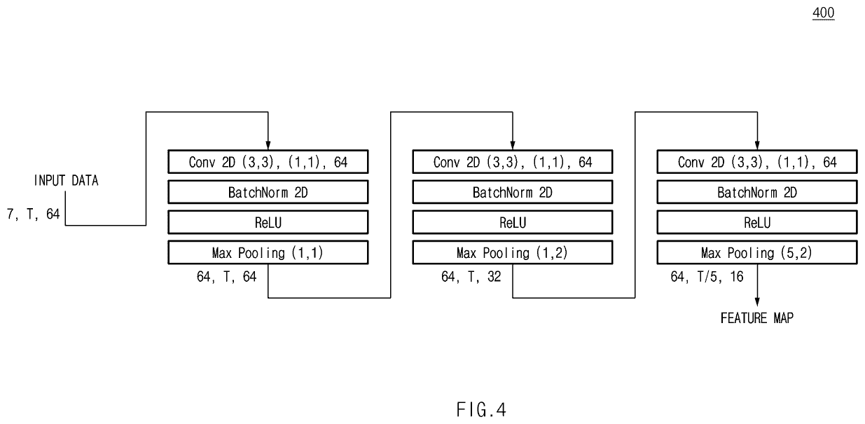

FIG. 4 is a diagram illustrating a convolutional neural network included in a sound source detection model in an electronic device according to an embodiment of the present disclosure.

FIG. 4 is a block diagram illustrating the configuration of a convolutional neural network included in a sound source detection model (e.g., the sound source detection model 300 of FIG. 3). A processor (e.g., the processor 110 of FIG. 1) may apply input data to a plurality of convolutional layers associated with a convolutional neural network 400 included in a sound source detection model to obtain a feature map including features associated with convolutions of the input data.

For example, the convolutional neural network 400 may represent a feature extraction network for preprocessing to simultaneously extract and compress feature information in the time and frequency domains from input data to generate a feature map suitable for attention-based processing of a sound source detection model.

For example, the input of the convolutional neural network 400 may include a total of 7 channels including a 4-channel log-mel spectrogram (e.g., 1 omnidirectional channel and 3 directional channels) and a 3-channel intensity vector (e.g., vector values of the x, y, and z axes representing spatial direction information). The input data, which is represented in tensor form, may have dimensions of, for example, (7, T, 64), where ‘T’ is the number of time frames and 64 is the number of mel frequency dimensions.

For example, the convolutional neural network 400 includes a total of three consecutive convolution blocks (Conv Blocks). The 2D convolution may have a kernel size of (3, 3), a stride of (1, 1), and a channel number of 64, and may extract local features considering both the time and frequency axes simultaneously. Batch normalization may achieve learning stabilization by normalizing the mean and variance for each batch. A rectified linear unit (ReLU) activation function may be applied to improve feature expressiveness by introducing nonlinearity. Time-frequency Max Pooling may perform dimensionality reduction and information compression by setting different pooling kernels for each block.

For example, the output of the convolutional neural network 400, which is a feature map composed in the form of a tensor of (64, T/5, 16), may be used as an input of the CST block of the subsequent stage. The feature map, which is obtained by compressing local information in terms of time and frequency, may include the key pattern desirable for inferring location information and event information while reducing the computational burden of sound source detection models.

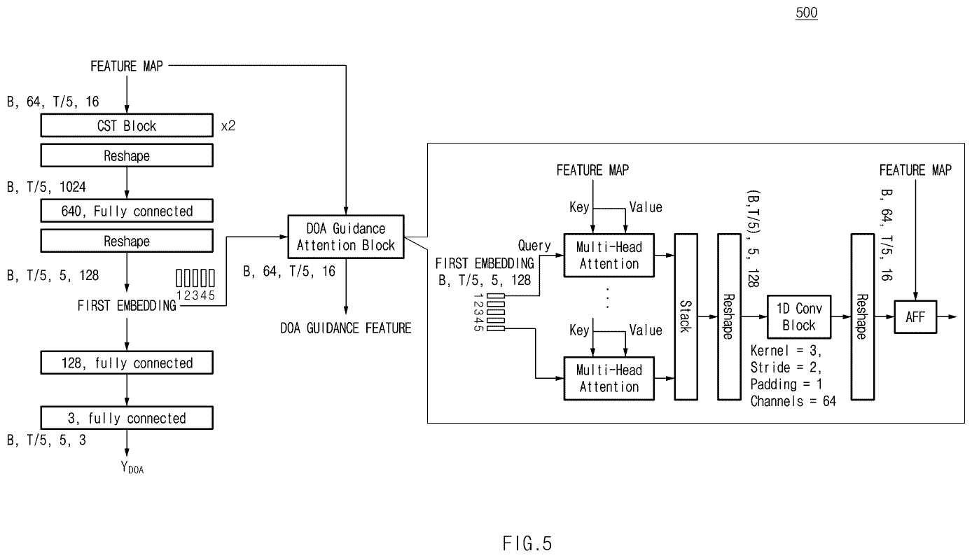

FIG. 5 is a diagram illustrating a first block included in a sound source detection model in an electronic device according to an embodiment of the present disclosure.

FIG. 5 is a block diagram illustrating the configuration of a first block 500 included in a sound source detection model (e.g., the sound source detection model 300 of FIG. 3). A processor (e.g., the processor 110 of FIG. 1) may obtain a first embedding including information about the location of a sound source by applying a feature map to a first channel-spectro-temporal (CST) block included in the first block 500.

For example, the processor may obtain a DOA guidance feature by applying the feature map and the first embedding to a DOA guidance attention block included in the first block 500. The processor may apply the feature map as a key and a value of the DOA guidance attention block, and apply the first embedding as a query of the DOA guidance attention block.

For example, the first block 500 may extract composite features for space-frequency-temporal information through the first CST block for the input feature map, and generate a DOA embedding (e.g., the first embedding) representing up to five directional information per time frame based on the features. The generated DOA embedding may be used as a query for the DOA guidance attention block, and the CNN feature map may be used as a key and value to perform multiple attention operations.

For example, the processor may generate a DOA guidance feature by combining output vectors with the feature map through an attention feature fusion technique after obtaining the output vectors focused on a specific direction through an attention operation and aligning them with the feature map in the same dimension through a 1D convolution and reshape process.

For example, the first CST block of the first block 500 may include two CST blocks. The first block 500 sequentially applies the two CST blocks included in the first CST block to a CNN-based feature map obtained from the input data. Each CST block may include a local perception unit (LPU), a CST attention layer, and an inverted residual feedforward network (IRFFN), which may represent an attention-based module that independently emphasizes the features of the channel, spectrum, and time axes. The output of the first CST block may be transformed into the form of (B, T/5, 1024), and then the final DOA prediction value may be determined through 640-dimensional, 128-dimensional, and 3-dimensional fully connected layers.

For example, the first block 500 may output up to maximum “M” (e.g., 5) first embedding (DOA embedding) vectors for each time frame based on the output of a 128-dimensional fully connected layer. In this case, the first embedding may have dimensions (B, T/5, 5 or 128).

For example, the DOA guidance attention block uses the first embedding as the attention query and the feature map as the key and value. The DOA guidance attention block may be trained using multi-head attention (MHA) such that each directional embedding focuses on a feature location corresponding to the directionality in the input sequence. In detail, the DOA guidance attention block may output highlighted output vectors in each direction based on the five direction-specific embeddings (Query) and the entire feature map (Key/Value). The DOA guidance attention block may output DOA guidance features through the attention feature fusion (AFF) technique by using adjusted output vectors and feature maps.

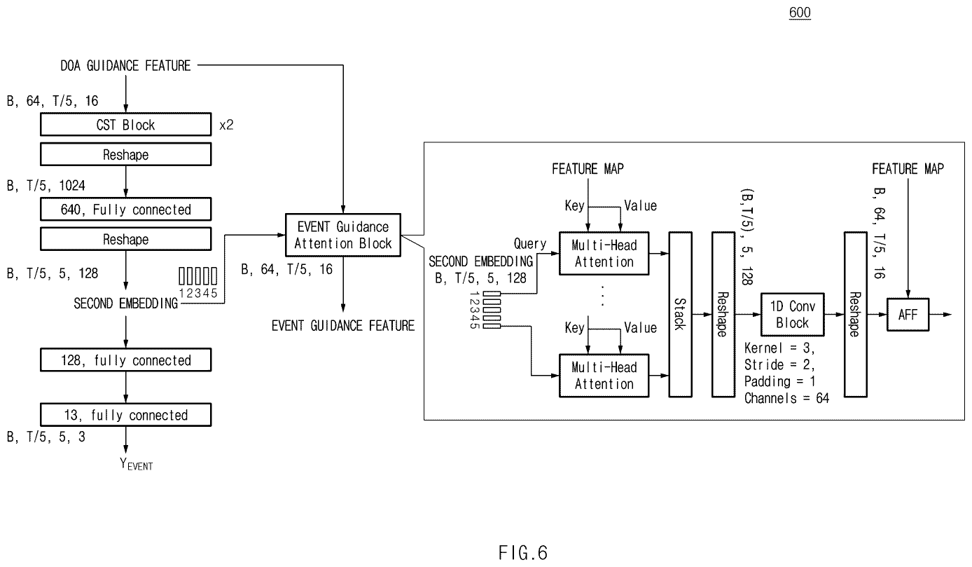

FIG. 6 is a diagram illustrating a second block included in a sound source detection model in an electronic device according to an embodiment of the present disclosure.

FIG. 6 is a block diagram illustrating the configuration of a second block 600 included in a sound source detection model (e.g., the sound source detection model 300 of FIG. 3). A processor (e.g., the processor 110 of FIG. 1) may apply the DOA guidance feature to the second CST block included in the second block 600 to obtain the second embedding including information about an event of a sound source.

The processor may obtain an event guidance feature by applying the feature map and the second embedding to the event guidance attention block included in the second block 600. The processor may apply the DOA guidance features as keys and values of the event guidance attention block, and apply the second embedding as the query of the event guidance attention block.

The second block 600 may use, as input, the DOA guidance feature extracted through the first block (e.g., the first block 500 of FIG. 5) to obtain a refined feature through the second CST block, and may apply the feature to the fully connected layer to generate the second embedding by time and direction. The second embedding is used as a query of the event guidance attention block, and the DOA guidance feature is used as a key and a value to perform an attention operation to obtain an output value that emphasizes a feature sensitive to the presence or absence of an event.

The DOA guidance feature provided as input may have a dimension of (B, 64, T/5, 16) and may be applied to the second CST block and to operations of refining and extracting complex information over channel, frequency, and time. The output of the second CST block may have the dimension of (B, T/5, 1024), and then, may represent the second embedding for each time frame and direction through a fully connected layer from 640 dimensions to 128 dimensions.

The second embedding, which has a dimension of (B, T/5, 5, 128), may have the maximum number of overlapping events of 5. Thereafter, the processor may finally obtain the output value of the presence or absence of a sound source event of dimension (B, T/5, 5, 13) by applying the second embedding to a fully connected layer from 128 dimensions to 13 dimensions.

The event guidance attention block may perform a multi-head attention (MHA) operation and apply attention such that the second embedding focuses on a region of the feature map that it is desired to emphasize for the time-direction features that it is desired to emphasize. The event guidance attention block forms a semantic-based connection between the direction, time and event.

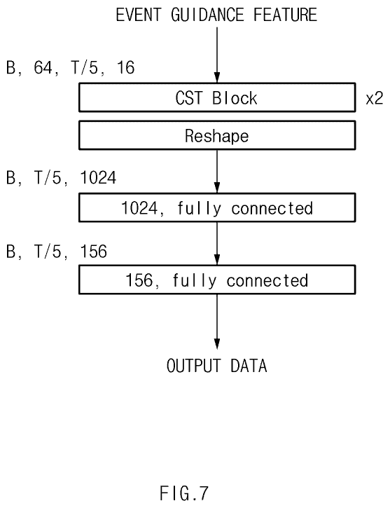

FIG. 7 is a diagram illustrating an output layer included in a sound source detection model in an electronic device according to an embodiment of the present disclosure.

FIG. 7 is a block diagram illustrating the configuration of an output layer included in a sound source detection model (e.g., the sound source detection model 300 of FIG. 3). A processor (e.g., the processor 110 of FIG. 1) may obtain the location of a sound source and whether an event of the sound source occurs by applying an event guidance feature to a third CST block (i.e., the CST Block illustrated in FIG. 7) connected to an event guide attention block.

The output layer may receive the event guidance feature provided from the second block (e.g., the second block 600 of FIG. 6) as input, infer the location of the sound source and whether an event occurs, and finally produce output data in the Multi-ACCDOA format (i.e., including the location of the sound source and whether an event occurs). The output layer may be configured to reflect spatial and event information extracted from the first block (e.g., the first block 500 of FIG. 5) and the second block, while maintaining the output format used by the single-task-based SELD system.

The multi-ACCDOA, which is output data in the present specification, may include the location of the sound source and whether an event of the sound source occurs. In detail, the multi-ACCDOA may represent an output format that simultaneously represents a direction vector (x, y, z) and an activation state for each sound event class per time frame. For example, an output format may have 13 sound classes and the maximum number of overlapping events (M) may have 5 dimensions. However, in the present specification, the final output size is set to 156 considering the number of classes and overlaps, and a fully connected layer may be described to include all direction vector information within the 156 dimensions.

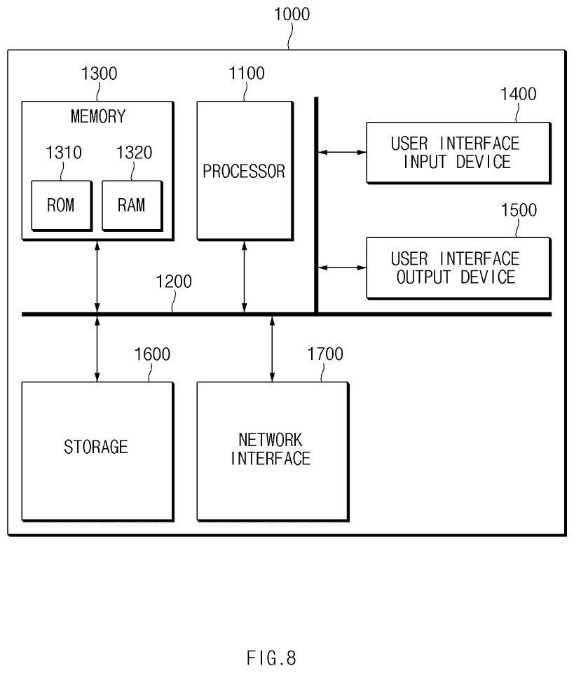

FIG. 8 is a block diagram illustrating a computing system related to an electronic device or a method of determining a sound source according to an embodiment of the present disclosure.

Referring to FIG. 8, a computing system 1000 related to an electronic device or a method of determining a sound source may include at least one processor 1100, a memory 1300, a user interface input device 1400, a user interface output device 1500, storage 1600, and a network interface 1700 connected through a bus 1200.

The processor 1100 may be a central processing unit (CPU) or a semiconductor device that processes instructions stored in the memory 1300 and/or the storage 1600. The memory 1300 and the storage 1600 may include various volatile or nonvolatile storage media. For example, the memory 1300 may include a read only memory (ROM) and a random access memory (RAM).

Accordingly, the processes of the method or algorithm described in relation to the embodiments of the present disclosure may be implemented directly by hardware executed by the processor 1100, a software module, or a combination thereof. The software module may reside in a storage medium (that is, the memory 1300 and/or the storage 1600), such as a RAM, a flash memory, a ROM, an EPROM, an EEPROM, a register, a hard disk, solid state drive (SSD), a detachable disk, or a CD-ROM.

The exemplary storage medium is coupled to the processor 1100, and the processor 1100 may read information from the storage medium and may write information in the storage medium. In another method, the storage medium may be integrated with the processor. The processor and the storage medium may reside in an application specific integrated circuit (ASIC). The ASIC may reside in a user terminal. In another method, the processor and the storage medium may reside in the user terminal as an individual component.

Although embodiments of the present disclosure have been described for illustrative purposes, those skilled in the art will appreciate that various modifications, additions and substitutions are possible, without departing from the scope and spirit of the disclosure.

The embodiments described above may be realized by hardware elements, software elements and/or combinations thereof. For example, the devices and components illustrated in the exemplary embodiments of the present disclosure may be implemented in one or more general-use computers or special-purpose computers, such as a processor, a controller, an arithmetic logic unit (ALU), a digital signal processor, a microcomputer, a field programmable gate array (FPGA), a programmable logic unit (PLU), a microprocessor or any device which may execute instructions and respond. A processing unit may implement an operating system (OS) or one or software applications running on the OS. Further, the processing unit may access, store, manipulate, process and generate data based at least in part on execution of software. It will be understood by those skilled in the art that although a single processing unit may be illustrated for convenience of understanding, the processing unit may include a plurality of processing elements and/or a plurality of types of processing elements. For example, the processing unit may include a plurality of processors or one processor and one controller. Also, the processing unit may have a different processing configuration, such as a parallel processor.

Software may include computer programs, codes, instructions or one or more combinations thereof and may configure a processing unit to operate in a desired manner or may independently or collectively control the processing unit. Software and/or data may be permanently or temporarily embodied in any type of machine, components, physical equipment, virtual equipment, computer storage media or units or transmitted signal waves so as to be interpreted by the processing unit or to provide instructions or data to the processing unit. Software may be dispersed throughout computer systems connected via networks and may be stored or executed in a dispersion manner. Software and data may be recorded in one or more computer-readable storage media.

The methods according to the above-described embodiments of the present disclosure may be implemented with program instructions which may be executed through various computer means and may be recorded in computer-readable media. The computer-readable media may also include, alone or in combination thereof, the program instructions, data files, data structures, and the like. The program instructions recorded in the media may be designed and configured specially for the exemplary embodiments of the present disclosure or be known and available to those skilled in computer software. Computer-readable media include magnetic media such as hard disks, floppy disks, and magnetic tape; optical media such as compact disc-read only memory (CD-ROM) disks and digital versatile discs (DVDs); magneto-optical media such as floptical disks; and hardware devices that are specially configured to store and perform program instructions, such as read-only memory (ROM), random access memory (RAM), flash memory, and the like. Program instructions include both machine codes, such as produced by a compiler, and higher level codes that may be executed by the computer using an interpreter.

The described hardware devices may be configured to act as one or more software modules to perform the operations of the above-described embodiments of the present disclosure, or vice versa.

The effects of the electronic device and method of determining a sound source according to the present disclosure are as follows.

According to the embodiments of the present disclosure, it is possible to improve the performance degradation of a conventional single-task system in a composite sound event localization and detection (SELD) system that estimates not only the direction of arrival (DOA) of a sound event but also the distance (sound distance estimation (SDE)).

In addition, according to the embodiments of the present disclosure, it is possible to maintain stable and consistent performance even in a new acoustic scene or unknown environment through a network structure configured so that information on the direction and distance of an event are clearly separated and learned.

In addition, according to the embodiments of the present disclosure, it is possible to support the performance of rescue and response missions by accurately determining the location of occurrence of incident-related sounds such as gunshots, glass breaking sounds, and screams in a CCTV surveillance system, to safely perform monitoring by determining the location and type of an event such as a baby crying, a doorbell, and an elderly person falling in a smart home environment, and to implement natural interaction with a user based on spatial understanding of the surrounding acoustic environment based at least in part on its application to a service robot.

In addition, various effects that are directly or indirectly understood through the present disclosure may be provided.

While a few exemplary embodiments have been shown and described with reference to the accompanying drawings, it will be apparent to those skilled in the art that various modifications and variations can be made from the foregoing descriptions. For example, adequate effects may be achieved even if the foregoing processes and methods are carried out in different order than described above, and/or the aforementioned elements, such as systems, structures, devices, or circuits, are combined or coupled in different forms and modes than as described above or be substituted or switched with other components or equivalents.

Thus, it is intended that the present disclosure covers other realizations and other embodiments of the present disclosure provided they come within the scope of the appended claims and their equivalents.

Therefore, the exemplary embodiments disclosed in the present disclosure are provided for the sake of descriptions, not limiting the technical concepts of the present disclosure, and it should be understood that such exemplary embodiments are not intended to limit the scope of the technical concepts of the present disclosure. The protection scope of the present disclosure should be understood by the claims below, and all the technical concepts within the equivalent scopes should be interpreted to be within the scope of the right of the present disclosure.

What is claimed is:

1. An electronic device comprising:
a memory configured to store computer-executable instructions; and
a processor configured to access the memory and when it executes the instructions, the processor is configured to:
determine sound source data including an omnidirectional information of a sound source and a directional information of the sound source;
obtain input data by preprocessing the sound source data; and
obtain a location of the sound source and whether an event of the sound source occurs by applying the input data to a sound source detection model,
wherein the sound source detection model includes a first block and a second block associated with an attention mechanism.

2. The electronic device of claim 1, wherein the processor is configured to:
obtain the sound source from an external device that obtains a signal associated with a first channel;
obtain the sound source data associated with a second channel by applying the sound source to a specified filter;
obtain a first spectrum associated with a time at which the sound source is obtained and a frequency of the sound source by performing a Fast Fourier transform on the sound source data; and
obtain a second spectrum having a specified number of dimensions by applying a filter associated with a mel-scale to the first spectrum.

3. The electronic device of claim 2, wherein the processor is configured to:
obtain an intensity vector of the second spectrum to reflect a spatial feature of the sound source; and
obtain the input data by concatenating the second spectrum and the intensity vector.

4. The electronic device of claim 1, wherein the processor is configured to:
obtain a feature map including a feature associated with convolution of the input data by applying the input data to a plurality of convolutional layers associated with a convolutional neural network included in the sound source detection model; and
apply the feature map to the first block.

5. The electronic device of claim 4, wherein the processor is configured to:
obtain a first embedding including information about the location of the sound source by applying the feature map to a first channel-spectro-temporal (CST) block included in the first block; and
obtain a direction-of-arrival (DOA) guidance feature by applying the feature map and the first embedding to a DOA guidance attention block included in the first block.

6. The electronic device of claim 5, wherein the processor is configured to:
apply the feature map as a key and a value of the DOA guidance attention block; and
apply the first embedding as a query of the DOA guidance attention block.

7. The electronic device of claim 5, wherein the processor is configured to:
obtain a second embedding having associated information about the event of the sound source by applying the DOA guidance feature to a second CST block included in the second block; and
obtain an event guidance feature by applying the feature map and the second embedding to an event guidance attention block included in the second block.

8. The electronic device of claim 7, wherein the processor is configured to:
apply the DOA guidance feature as a key and a value of the event guidance attention block; and
apply the second embedding as a query of the event guidance attention block.

9. The electronic device of claim 7, wherein the processor is configured to obtain the location of the sound source and whether the event of the sound source occurs by applying the event guidance feature to a third CST block connected to the event guidance attention block.

10. A method of determining a sound source, the method comprising:
determining sound source data including omnidirectional information of the sound source and directional information of the sound source;
obtaining input data by preprocessing the sound source data; and
obtaining a location of the sound source and whether an event of the sound source occurs by applying the input data to a sound source detection model,
wherein the sound source detection model includes a first block and a second block associated with an attention mechanism.

11. The method of claim 10, wherein the obtaining the location of the sound source and whether the event of the sound source occurs includes:
obtaining the sound source from an external device that obtains a signal associated with a first channel;
obtaining the sound source data associated with a second channel by applying the sound source to a specified filter;
obtaining a first spectrum associated with a time at which the sound source is obtained and a frequency of the sound source by performing a fast Fourier transform on the sound source data; and
obtaining a second spectrum having a specified number of dimensions by applying a filter associated with a mel-scale to the first spectrum.

12. The method of claim 11, wherein the obtaining the location of the sound source and whether the event of the sound source occurs includes:
obtaining an intensity vector of the second spectrum to reflect a spatial feature of the sound source; and
obtaining the input data by concatenating the second spectrum and the intensity vector.

13. The method of claim 10, wherein the obtaining the location of the sound source and whether the event of the sound source occurs includes:
obtaining a feature map including a feature associated with convolution of the input data by applying the input data to a plurality of convolutional layers associated with a convolutional neural network included in the sound source detection model; and
applying the feature map to the first block.

14. The method of claim 13, wherein the obtaining the location of the sound source and whether the event of the sound source occurs includes:
obtaining a first embedding including information about the location of the sound source by applying the feature map to a first channel-spectro-temporal (CST) block included in the first block; and
obtaining a direction-of-arrival (DOA) guidance feature by applying the feature map and the first embedding to a DOA guidance attention block included in the first block.

15. The method of claim 14, wherein the obtaining the location of the sound source and whether the event of the sound source occurs includes:
applying the feature map as a key and a value of the DOA guidance attention block; and
applying the first embedding as a query of the DOA guidance attention block.

16. The method of claim 14, wherein the obtaining the location of the sound source and whether the event of the sound source occurs includes:
obtaining a second embedding having associated information about the event of the sound source by applying the DOA guidance feature to a second CST block included in the second block; and
obtaining an event guidance feature by applying the feature map and the second embedding to an event guidance attention block included in the second block.

17. The method of claim 16, wherein the obtaining the location of the sound source and whether the event of the sound source occurs includes:
applying the DOA guidance feature as a key and a value of the event guidance attention block; and
applying the second embedding as a query of the event guidance attention block.

18. The method of claim 16, wherein the obtaining the location of the sound source and whether the event of the sound source occurs includes obtaining the location of the sound source and whether the event of the sound source occurs by applying the event guidance feature to a third CST block connected to the event guidance attention block.

19. A sound detection system, comprising:
a microphone array configured to capture sound signals from multiple directions and including at least an omnidirectional microphone and a directional microphone;
a signal processing unit configured to convert the captured sound signals into digital sound source data including omnidirectional information and directional information; and
a processor configured to:
obtain input data by processing the digital sound source data,
obtain a location of a sound source, and
determine whether an event associated with the sound source occurs by applying, to the input data, a sound source detection model configured based at least in part on an attention mechanism.

20. The sound detection system of claim 19, wherein the digital sound source data comprises:
a spectrogram corresponding to at least an omnidirectional channel and a directional channel; and
an intensity vector corresponding to spatial direction information.
